(19) United States
(12) Patent Application Publication
(10) Pub. No.: US 2026/0138908 A1
(43) Pub. Date: May 21, 2026

(54) DISTRIBUTED DELIVERY OF LOW VISCOSITY GLASS

(71) Applicant: CORNING INCORPORATED, CORNING, NY (US)

(72) Inventors: Zakaria Allam, Avon (FR); Allan Mark Fredholm, Vulaines sur Seine (FR); Michael Charles Gerrish, Corning, NY (US); Douglas Hull Jennings, Corning, NY (US); Miki Eugene Kunitake, San Diego, CA (US); Joseph William Mattson, Painted Post, NY (US); Boris Nikolayevich Tsvetkov, Espoo (FI)

(21) Appl. No.: 19/389,892

(22) Filed: Nov. 14, 2025

Related U.S. Application Data
(60) Provisional application No. 63/722,302, filed on Nov. 19, 2024.

(51) Int. Cl. C03B 17/06; C03B 13/04

(52) U.S. Cl. CPC C03B 17/068; C03B 13/04; C03B 17/067; C03B 2203/04

(57) ABSTRACT

A method of forming a glass sheet including flowing molten glass from one or more channels of a glass delivery system as a molten glass body, the molten glass having a viscosity of about 1000 poise or less, and the molten glass body having a length, a width, and a height such that the height extends in a direction from the one or more channels towards the shaping components and the length is perpendicular to the width. A difference between a flow rate of the molten glass body at any point along a distance of 80% or more of the length of the molten glass body and an average flow rate of the molten glass body across the entire length of the molten glass body is about 20.0% or less of the average flow rate of the molten glass across the entire length of the molten glass body.

This Application claims the benefit of priority to U.S. Provisional Patent Application Ser. No. 63/722302 filed on Nov. 19, 2024, the content of which is relied upon and incorporated herein by reference in its entirety.

### FIELD OF TECHNOLOGY

The present disclosure relates generally to forming glass structures, and more specifically to distributed delivery of low viscosity glass.

### BACKGROUND

Glass is a key component in a wide range of industrial, academic, and commercial applications (e.g., media electronic devices, lighting devices, medical devices, and so forth). In some cases, glass may be manufactured to achieve desired optical and/or mechanical properties for implementation in said industrial, academic, and commercial applications. For example, glass may be manufactured to achieve a relatively thin profile and a high refractive index while still maintaining a high fracture toughness. Glass with a high refractive index may be used in, for example, augmented reality devices and organic light emitting diode (OLED) lighting devices (e.g., televisions, monitors, screens), among other examples. In other examples, glass sheets may be used for liquid crystal display (LCD) displays for various computing and display devices.

Glass with such high refractive index values tend to have low viscosity. However, low viscosity glass can be difficult to manufacture with conventional manufacturing processes as the glass does not easily convene into a coherent glass ribbon, as compared with glass having a relatively higher viscosity. Accordingly, it is desirable to provide consistent, efficient, and cost-effective manufacturing processes that can produce thin glass sheets while accommodating for the low viscosity properties of the glass.

### SUMMARY

The described techniques relate to improved methods, systems, devices, and apparatuses that support distributed delivery of low viscosity glass. Generally, the described techniques provide for delivering low viscosity glass to one or more shaping components configured to shape the low viscosity glass into a continuous sheet that has an approximately uniform fluid profile and an approximately uniform temperature profile. For example, the described techniques may include delivering molten glass material to a fluid containment structure such as a chamber. The fluid containment structure may be configured to distribute and deliver the molten glass material at a low viscosity to the one or more shaping components, where the one or more shaping components may apply forces to distribute and flatten the molten glass material into the continuous sheet. For example, the chamber may uniformly distribute the molten glass material using obstructions or channels which the molten glass material may flow through.

According to a first embodiment, a method of forming a glass sheet, the method comprising flowing molten glass from one or more channels of a glass delivery system as a molten glass body to one or more shaping components, the molten glass having a viscosity of about 1000 poise or less, and the molten glass body having a length, a width, and a height such that the height extends in a direction from the one or more channels towards the shaping components and the length is perpendicular to the width, wherein a ratio of the length of the molten glass body to the width of the molten glass body is about 40:1 or greater and a difference between a flow rate of the molten glass body at any point along a distance of 80% or more of the length of the molten glass body and an average flow rate of the molten glass body across the entire length of the molten glass body is about 20.0% or less of the average flow rate of the molten glass across the entire length of the molten glass body.

According to a second embodiment, a method of forming a glass sheet, the method comprising flowing molten glass from one or more channels of a glass delivery system as a molten glass body to one or more shaping components, the molten glass having a viscosity of about 1000 poise or less, and the molten glass body having a length, a width, and a height such that the height extends in a direction from the one or more channels towards the shaping components and the length is perpendicular to the width, wherein a ratio of the length of the molten glass body to the width of the molten glass body is about 40:1 or greater and a portion of the molten glass body that spans a distance of at least 80% of the length of the molten glass body comprises a first end and a second end, and a flow rate of the molten glass at the first end is at least 5% greater than a flow rate of the molten glass at the second end of the molten glass body.

According to a third embodiment, a method of forming a glass sheet, the method comprising flowing molten glass in a y-axis direction from one or more channels of a glass delivery system to one or more shaping components, the molten glass having a viscosity of about 250 poise or less, and rolling the molten glass into a continuous glass sheet with the one or more shaping components, the continuous glass sheet having a thickness of about 10.0 mm or less and a length in an x-axis direction of about 100 mm or greater.

According to a fourth embodiment, a glass manufacturing apparatus comprising a glass delivery system comprising a chamber with at least a first channel and a second channel and one or more shaping components downstream of the chamber. The first channel and the second channel being configured to deliver molten glass from the chamber to the one or more shaping components such that the first channel is configured to deliver the molten glass from the chamber at a different flow rate from the second channel, and the shaping components being configured to roll the molten glass into a continuous glass sheet. Furthermore, the one or more shaping components comprising at least two rollers with a diameter of about 1 inch or greater.

### BRIEF DESCRIPTION OF THE DRAWINGS

FIG. 1A shows a schematic of a glass delivery system that supports distributed delivery of low viscosity glass, according to embodiments of the present disclosure;

FIG. 1B shows a side view of the glass delivery system of FIG. 1A, according to embodiments of the present disclosure;

FIG. 1C shows a perspective view of a portion of the glass delivery system of FIG. 1A, according to the embodiments of the present disclosure;

FIG. 1D shows a perspective view of a portion of the glass delivery system of FIG. 1A with attachment components, according to embodiments of the present disclosure;

FIG. 2 shows another schematic of the glass delivery system of FIG. 1A with molten glass material within the system, according to embodiments of the present disclosure;

FIG. 3 shows a molten glass body, according to embodiments of the present disclosure;

FIGS. 4A-4C shows various flow rates of the molten glass material within the molten glass body of FIG. 3, according to embodiments of the present disclosure;

FIG. 5 shows a portion of the glass delivery system of FIG. 1A with a puddle above the shaping components, according to embodiments of the present disclosure;

FIG. 6 shows another schematic of a perspective view of a portion of a glass delivery system that supports distributed delivery of low viscosity glass, according to embodiments of the present disclosure;

FIG. 7 shows another chamber and distribution component of the glass delivery system, according to embodiments of the present disclosure;

FIG. 8 also shows another chamber and distribution component of the glass delivery system, according to embodiments of the present disclosure;

FIGS. 9A and 9B show another chamber of the glass delivery system, according to embodiments of the present disclosure;

FIGS. 10A and 10B also show another chamber of the glass delivery system, according to embodiments of the present disclosure; and

FIG. 11 shows a flowchart illustrating methods that support distributed delivery of low viscosity glass, according to embodiments of the present disclosure.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

Disclosed are components (including materials, compounds, compositions, and method steps) that can be used for, in conjunction with, in preparation for, or as embodiments of the disclosed optical elements and methods for making optical elements. It is understood that when combinations or subsets, interactions of the components are disclosed, each component individually and each combination of two or more components is also contemplated and disclosed herein even if not explicitly stated. If, for example, if a combination of components A, B, and C is disclosed, then each of A, B, and C is individually disclosed as is each of the combinations A-B, B-C, A-C, and A-B-C. Similarly, if components D, E, and F are individually disclosed, then each combination D-E, E-F, D-F, and D-E-F is also disclosed. This concept applies to all aspects of this disclosure including, but not limited to, components corresponding to materials, compounds, compositions, and steps in methods.

In this specification and in the claims which follow, reference will be made to a number of terms which shall be defined to have the following meanings:

“Include,” “includes,” or like terms means encompassing but not limited to, that is, inclusive and not exclusive.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, left and right, and the like, are used solely to distinguish one entity or action from another entity or action, without necessarily requiring or implying any actual such relationship or order between such entities or actions.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are otherwise joined to each other through one or more intervening materials. Elements in contact may be rigidly or non-rigidly joined. Contacting refers to placing two elements in direct or indirect contact. Elements in direct (indirect) contact may be said to directly (indirectly) contact each other.

The construction and arrangement of the elements of the present disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

The indefinite article “a” or “an” and its corresponding definite article “the” as used herein means at least one, or one or more, unless specified otherwise.

The terms “viscosity” or “liquidus viscosity” refer to the viscosity of the glass composition at the liquidus temperature of the glass composition and is measured in accordance with ASTM C965-96(2012), titled “Standard Practice for Measuring Viscosity of Glass Above the Softening Point”.

In the appended figures, similar components or features may have the same reference label. Moreover, various components of the same type may be distinguished by following the reference label by a dash and a second label that distinguishes among the similar components. If only the first reference label is used in the specification, the description is applicable to any one of the similar components having the same first reference label irrespective of the second reference label.

The claims as set forth below are incorporated into and constitute part of this Detailed Description.

It is known in the art to produce glass with a relatively thin profile with various optical properties. For example, some glass materials may have a relatively high refractive index (e.g., based on a composition of the glass material), which may be implemented in many devices across many industries due to a relatively increased field of view and other beneficial properties. Forming relatively thin glass with high refractive index, however, may be associated with a number of manufacturing challenges. More specifically, glass with a relatively high refractive index is usually associated with a low viscosity, which poses manufacturing challenges.

In most conventional manufacturing process, relatively thin glass sheets are formed by delivering molten glass from a distributed delivery system to rollers. The distributed delivery system controls the flow rate of the molten glass in order to ensure a controlled and even delivery of the molten glass to the rollers. With such controlled and even delivery, a uniform glass sheet can be produced from the rollers. In most conventional distributed delivery systems, the molten glass is delivered to the rollers via a slot in the distributed delivery system. Glass with relatively higher viscosities are able to convene into a coherent body as the glass leaves the slot of the distributed delivery system. This enables the glass to flow into the rollers as a coherent body. But glass with relatively lower viscosities have different properties (including different surface tension properties) and do not convene into such a coherent body. Instead, the glass leaves the distributed delivery system as droplets rather than a coherent body. Therefore, glass with relatively lower viscosities do not flow into the rollers as a coherent and uniform body, so that the produced glass sheet is not a uniform sheet. Accordingly, conventional manufacturing processes work well with relatively higher viscosities glass but are not able to produce uniform glass sheets when using relatively lower viscosities glass.

In the embodiments disclosed herein, a glass delivery system is disclosed that produces glass sheets from relatively low viscosity molten glass. In accordance with the embodiments disclosed herein, a glass delivery system is configured to uniformly distribute molten glass material and deliver the molten glass material at low viscosity to one or more shaping components (e.g., rollers) for forming a uniform and continuous glass sheet (e.g., a solidified glass material). The glass delivery system is configured to uniformly distribute and deliver low viscosity molten glass material to the one or more shaping components such that the resulting continuous glass sheet has an approximately uniform fluid profile and an approximately uniform temperature profile. For example, the continuous glass sheet may be formed such that minor variations in the temperature or shape of the continuous glass sheet are reduced compared to conventional systems. Implementing the glass delivery system as described herein may reduce costs, reduce operational durations, and generate improved resulting glass structures associated with using low viscosity glass compositions.

Reference will now be made in detail to illustrative embodiments of the present description.

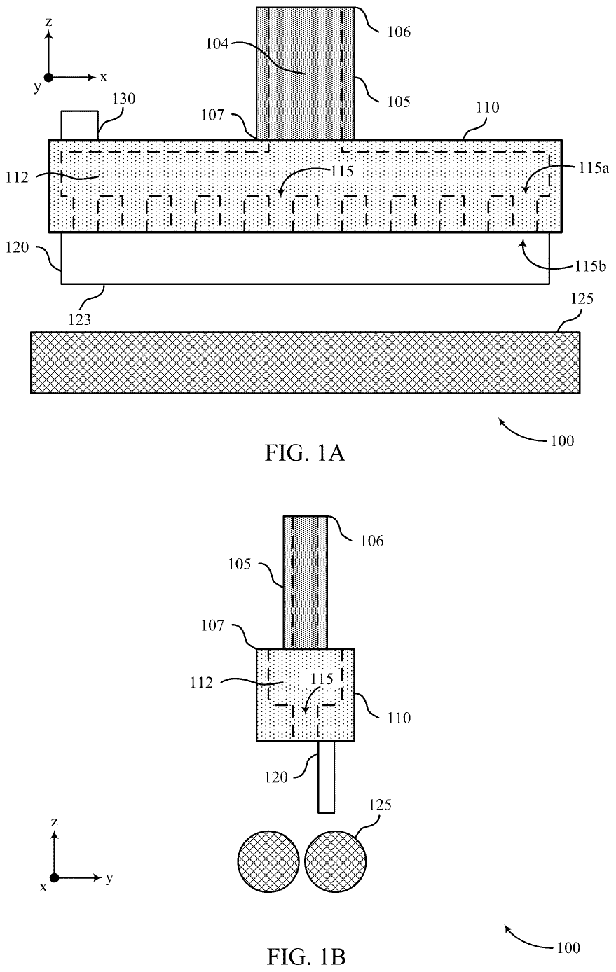

FIG. 1A illustrates a glass delivery system 100 that supports distributed delivery of low viscosity glass in accordance with aspects of the present disclosure. The glass delivery system 100 may include various glass forming components operable to deliver, distribute, and shape a molten glass material. For example, a fluid containment structure of the glass delivery system 100 is configured to uniformly distribute the molten glass material and deliver the molten glass material at low viscosity to one or more shaping components (e.g., forming rollers) of the glass delivery system 100 for forming a continuous glass sheet. The glass delivery system 100 may include components to modify the distribution of molten glass material such that the resulting continuous glass sheet has an approximately uniform fluid profile and an approximately uniform temperature profile.

For example, FIG. 1A illustrates a front view of the glass delivery system 100, while FIG. 1B illustrates a side view of the glass delivery system 100. Although the glass delivery system 100 illustrates examples of relative sizes and quantities of various features, aspects of the glass delivery system 100 may be implemented with other relative sizes or quantities of such features in accordance with examples as disclosed herein.

The glass delivery system 100 may comprise an inlet component 105 configured to deliver and transport a continuous flow of the molten glass material. The inlet component 105 comprises one or more openings 104 through which the molten glass material may flow. As shown in FIG. 1A, the one or more openings 104 may each include an entry orifice 106 and an exit orifice 107. In embodiments, the inlet component 105 is a cylindrical structure, a prism structure, or a funnel structure. In some embodiments, the glass delivery system 100 comprises multiple inlet components 105. Furthermore, although FIGS. 1A and 1B show the opening 104 as having one entry orifice 106 and one exit orifice 107, the opening 104 may comprise more than one of each of the entry orifice 106 and the exit orifice 107.

Inlet component 105 may receive the molten glass material from, for example, a furnace component (not shown) configured to heat the molten glass material to a relatively pliable state. The inlet component 15 then delivers the molten glass material to a chamber 110 of the glass delivery system 100.

The molten glass material delivered to chamber 110 may have a relatively low viscosity. In embodiments the molten glass material has a viscosity of about 2000 poise or less, or about 1750 poise or less, or about 1500 poise or less, or about 1250 poise or less, or about 1000 poise or less, or about 750 poise or less, or about 500 poise or less, or about 250poise or less, or about 200 poise or less, or about 150 poise or less, or about 100 poise or less, or about 50 poise or less, or about 25 poise or less, or about 20 poise or less, or about 10poise or less, or about 5 poise or less, or about 3 poise or less, or about 2.5 poise or less, or about 2 poise or less, or about 1 poise or less, or about 0.75 poise or less, or about 0.50 poise or less, or about 0.25 poise or less, or about 0.20 poise or less, or about 0.10 poise or less. Additionally or alternatively, the molten glass material delivered to chamber 100 may have a viscosity of about 0.10 poise or greater, or about 0.20 poise or greater, or about 0.25 poise or greater, or about 0.50 poise or greater, or about 0.75 poise or greater, or about 1 poise or greater, or about 2 poise or greater, or about 2.5 poise or greater, or about 3 poise or greater, or about 5 poise or greater, or about 10 poise or greater, or about 20 poise or greater, or about 25 poise or greater, or about 50 poise or greater, or about 100 poise or greater, or about 150poise or greater, or about 200 poise or greater, or about 250 poise or greater, or about 500poise or greater, or about 750 poise or greater, or about 1000 poise or greater, or about 1250poise or greater, or about 1500 poise or greater, or about 1750 poise or greater, or about 2000poise or greater. In embodiments, the viscosity is from about 0.10 poise to about 2000 poise, or about 0.20 poise to about 1750 poise, or about 0.25 poise to about 1500 poise, or about 0.50 poise to about 1250 poise, or about 0.75 poise to about 1000 poise, or about 1 poise to about 750 poise, or about 2 poise to about 500 poise, or about 2.5 poise to about 250 poise, or about 3 poise to about 200 poise, or about 5 poise to about 150 poise, or about 10 poise to about 100 poise, or about 20 poise to about 50 poise, or about 25 poise to about 50 poise, or any range encompassing these endpoints.

In embodiments, the molten glass material delivered to chamber 110 may have a temperature of about 300° C. or greater, or about 500° C. or greater, or about 800° C. or greater, or about 1000° C. or greater, or about 1200° C. or greater, or in a range from about 300° C. to about 1900° C., or about 400° C. to about 1800° C., or about 500° C. to about 1700° C., or about 600° C. to about 1600° C., or about 700° C. to about 1500° C., or about 800° C. to about 1400° C., or about 900° C. to about 1300° C., or about 1000° C. to about 1200° C., or about 1000° C. to about 1650° C., or about 1000° C. to about 1500° C., or about 1000° C. to about 1400° C., or any range encompassing these endpoints.

The chamber 110 is configured to collect, distribute, and further transport the molten glass material. The chamber 110 may be an enclosed fluid containment structure comprising a cavity 112 configured to temporarily store, distribute, and transport the molten glass material. In embodiments, cavity 112 is enclosed by walls of chamber 110, while in other embodiments, cavity 112 is open and not completely enclosed by chamber 110. FIGS. 1A and 1B depict an embodiment in which cavity 112 is enclosed by the walls of chamber 110. Cavity 112 may receive the molten glass material from the inlet component 105 via the exit orifice 107 and collect the molten glass material for a duration of time. During that duration of time, the molten glass material may distribute throughout the cavity 112 of the chamber 110. For example, the molten glass material may spread throughout the cavity 112 and assume the shape of the cavity 112. In embodiments, the chamber 110 may include one or more internal structures configured to uniformly distribute the molten glass material within the cavity 112. In some such embodiments, the one or more internal structures may be shaped to facilitate the approximately uniform fluid profile and the approximately uniform temperature profile of the resultant continuous glass sheet.

As shown in FIG. 1A, the chamber 110 may include one or more channels 115 configured to distribute the molten glass material out of the cavity 112 and to one or more shaping components 125. In embodiments, chamber 110 further comprises a distribution component120 and the channels 115 are configured to distribute the molten glass material out of the cavity 112 and to the distribution component 120. Therefore, the molten glass material is delivered to the distribution component 120 before being delivered to the one or more shaping components 125.

The one or more channels 115 may each comprise a passageway, an orifice, an aperture, or a conduit within chamber 110. The channels 115 may each extend from cavity 110 to distribution component 120 such that the channels 115 are configured to transport the molten glass material out of the cavity 112. However, the size of channels 115 and/or the number of channels may constrict and partially restrict the flow of the molten glass material out of the cavity 112, such that the molten glass material accumulates in cavity 112 to form a reservoir of molten glass material. More specifically, the channels 115 create distinct passageways for the flow of molten glass material out of cavity 112. But the limited number of passageways creates a partial obstruction of the flow of molten glass material so that some of the molten glass material becomes dammed up within cavity 112 and forms the reservoir. Therefore, at least a portion of the molten glass material accumulates in cavity 112 while awaiting its movement out of cavity 112 through the one or more channels 115.

The channels 115 may each have a first diameter at a first opening 115a of the channel 115 and a second diameter at a second opening 115b of the channel 115. As shown in FIG. 1A, the first opening 115a may be positioned within a body of chamber 110 and the second opening 115b may be at an outer surface of chamber 110. In embodiments, the first diameter is equal to the second diameter. In other embodiments, the first diameter is not equal to the second diameter. For example, the first diameter may be larger than the second diameter. Thus, the cross-sectional profile of each channel 115 may be uniform or non-uniform. It is also contemplated that one or more first diameters of one or more channels 115 may be the same or different from one or more first diameters of one or more different channels 115. Similarly, one or more second diameters of one or more channels 115 may be the same or different from one or more second diameters of one or more different channels 115.

In the embodiment shown in FIG. 1A, chamber 110 comprises 10 distinct channels 115. However, it is also contemplated that chamber 110 may comprise more or less channels 115, such as, for example, 1 or more channels, or 2 or more channels, or 4 or more channels, or 5 or more channels, or 10 or more channels, or 20 or more channels, or 30 or more channels, or 40 or more channels, or 50 or more channels, or 60 or more channels, or 70 or more channels, or 80 or more channels, or 90 or more channels, or 100 or more channels. The channels may be arranged in various configurations and patterns on glass delivery system 100.

The molten glass material flows out of each channel 115 with a specific flow rate, which is dependent on the size and shape of that channel and also the number of channels in chamber 110. In embodiments, the channels 115 may be configured to uniformly distribute the molten glass material out of the channels 115 so that the molten glass material flows from all of the channels 115 with the same flow rate (or substantially the same flow rate). In other embodiments, the channels 115 are configured to non-uniformly distribute the molten glass material out of the channels 115 so that one or more channels distribute the molten glass material with a higher flow rate than one or more other channels. For example, with reference to FIG. 1A, a left side of chamber 110 may comprise channels 115 configured to distribute the molten glass material with a higher flow rate than the right side of chamber 110. Such may be due to, for example, more channels on the left side of chamber 110 and/or channels with a larger diameter on the left side of chamber 110. As discussed further below, distribution component 120 helps to shape the profile of the molten glass material as it flows out of channels 115.

The distribution component 120 is configured to distribute and transport the molten glass material from chamber 110 (via channels 115) and to the shaping components 125. In embodiments, the distribution component 120 is a plate or fin (or a combination of two or more plates or fins) that extends from chamber 110. Furthermore, in embodiments, the distribution component 120 comprises a lip 123, which forms an outer edge of the component. In embodiments, the molten glass material flows from the lip 123 to the shaping components 125. Thus, the lip 123 may be positioned on the distribution component 120 such that it is furthest from the channels 115 and closest to the shaping components 125. As shown in FIGS. 1A and 1B, the distribution component 120 is positioned between cavity 112 and shaping components 125. In some embodiments, the distribution component 120 is angled with regard to a center, longitudinal axis of chamber 110 (such that these components are positioned obliquely to each other). For example, a center, longitudinal axis of the distribution component 120 may be perpendicular to a center, longitudinal axis of chamber 110. In other embodiments, as shown in FIG. 1B, the distribution component 120 extends straight downward from cavity 112. In any case, the distribution component 120 facilitates the continuous flow of the molten glass material from the cavity 112 and to the shaping components 125. Thus, the molten glass material may flow directly from channels 115 and onto the distribution component 120 before flowing to shaping components 125.

In embodiments, the distribution component 120 distributes the molten glass material so that it flows from the distribution component 120 and onto the shaping components 125 with the same (or approximately the same) flow rate and temperature profile throughout. Thus, the molten glass material flows with a uniform profile to the shaping components 125. In other embodiments, the distribution component distributes the molten glass material so that it flows from the distribution component and onto the shaping components 125 with a non-uniform profile. In these embodiments, at least one of the flow rate and temperature of the molten glass material may vary across the material.

The distribution component 120 may support multiple discrete streams of molten glass flowing across the component such that the multiple discrete streams of glass merge into one continuous body while flowing on the distribution component 120 and/or after exiting the distribution component 120. For example, multiple discrete streams of molten glass may be dispersed from the multiple discrete channels 115, and those multiple discrete streams of molten glass may merge into one continuous body due to the distribution component 120.

Although FIGS. 1A and 1B show the glass delivery system 100 as comprising a single distribution component 120 for transporting the molten glass material to the shaping components 125, the glass delivery system 100 may comprise multiple distribution components 120. Furthermore, in some embodiments, the glass delivery system 100 may not comprise the distribution component 120, and instead the molten glass material may be transmitted directly from the channels 115 of the chamber 110 to the shaping components 125.

In some embodiments, sidewalls of the chamber 110, sidewalls of the channels 115, sidewalls of the distribution component 120, or any combination thereof may be made of a material or comprise a coating configured to facilitate movement of the molten glass material through the glass delivery system 100, such as platinum or platinum rhodium or platinum gold.

Shaping components 125 are configured to shape the molten glass material into a continuous glass sheet, for example, a continuous glass ribbon. In embodiments, the shaping components 125 comprise rollers configured to distribute and flatten the molten glass material delivered from the distribution component 120 or delivered directly from the channels 115. In embodiments, the shaping components 125 comprise two or more rollers, such as a first set of rollers and a second set of rollers. The rollers apply a force to the molten glass material to flatten the molten glass material to a desired thickness (e.g., less than about 2 mm, less than about 1 mm, less than about 0.8 mm, less than about 0.3 mm). The rollers may each have a diameter of about 1 inch or greater, or about 2 inches or greater, or about 3 inches or greater, or about 4 inches or greater, or about 5 inches or greater, or about 6 inches or greater, or in a range from about 1 inch to about 6 inches, or about 2 inches to about 5 inches, or about 3 inches to about 4 inches, or any range encompassing these endpoints.

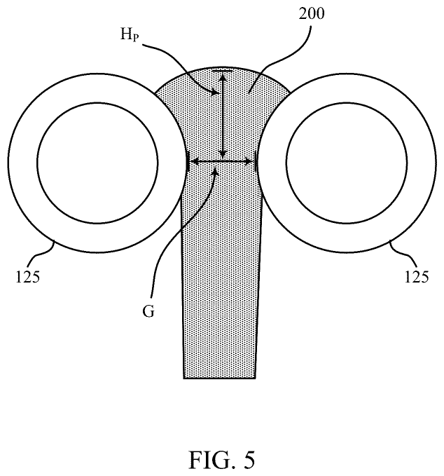

A gap (G) may separate the rollers, such that the gap has a length between the rollers of about 0.1 mm to about 10 mm, or about 0.2 mm to about 0.9 mm, or about 0.3 mm to about 0.8 mm, or about 0.4 mm to about 0.7 mm, or about 0.5 mm to about 0.6 mm, or about 0.3 mm to about 0.5 mm, or about 0.4 mm to about 0.5 mm, or any range encompassing these endpoints. With reference to FIG. 5, the gap (G) is the shortest distance between the outer surfaces of the rollers.

The molten glass material delivered to the shaping components 125 (either from distribution component 120 or directly from channels 115) may have a relatively low viscosity. In embodiments the molten glass material delivered to the shaping components 125 has a viscosity of about 2000 poise or less, or about 1750 poise or less, or about 1500 poise or less, or about 1250 poise or less, or about 1000 poise or less, or about 750 poise or less, or about 500 poise or less, or about 250 poise or less, or about 200 poise or less, or about 150 poise or less, or about 100 poise or less, or about 50 poise or less, or about 25 poise or less, or about 20 poise or less, or about 10 poise or less, or about 5 poise or less, or about 3 poise or less, or about 2.5 poise or less, or about 2 poise or less, or about 1 poise or less, or about 0.75 poise or less, or about 0.50 poise or less, or about 0.25 poise or less, or about 0.20 poise or less, or about 0.10 poise or less. Additionally or alternatively, the molten glass material delivered to the shaping components 125 may have a viscosity of about 0.10 poise or greater, or about 0.20 poise or greater, or about 0.25 poise or greater, or about 0.50 poise or greater, or about 0.75 poise or greater, or about 1 poise or greater, or about 2 poise or greater, or about 2.5 poise or greater, or about 3 poise or greater, or about 5 poise or greater, or about 10 poise or greater, or about 20 poise or greater, or about 25 poise or greater, or about 50 poise or greater, or about 100 poise or greater, or about 150 poise or greater, or about 200 poise or greater, or about 250 poise or greater, or about 500 poise or greater, or about 750 poise or greater, or about 1000 poise or greater, or about 1250 poise or greater, or about 1500 poise or greater, or about 1750 poise or greater, or about 2000 poise or greater. In embodiments, the viscosity is from about 0.10 poise to about 2000 poise, or about 0.20 poise to about 1750 poise, or about 0.25 poise to about 1500 poise, or about 0.50 poise to about 1250 poise, or about 0.75 poise to about 1000 poise, or about 1 poise to about 750 poise, or about 2 poise to about 500 poise, or about 2.5 poise to about 250 poise, or about 3 poise to about 200 poise, or about 5 poise to about 150 poise, or about 10 poise to about 100 poise, or about 20 poise to about 50 poise, or about 25 poise to about 50 poise, or any range encompassing these endpoints.

The molten glass delivered to the shaping components 125 may have the same or different viscosity from the molten glass delivered to the chamber 110.

In embodiments, the molten glass material delivered to the shaping components 125 may have a temperature of about 300° C. or greater, or about 500° C. or greater, or about 800° C. or greater, or about 1000° C. or greater, or about 1200° C. or greater, or in a range from about 300° C. to about 1900° C., or about 400° C. to about 1800° C., or about 500° C. to about 1700° C., or about 600° C. to about 1600° C., or about 700° C. to about 1500° C., or about 800° C. to about 1400° C., or about 900° C. to about 1300° C., or about 1000° C. to about 1200° C., or about 1000° C. to about 1650° C., or about 1000° C. to about 1500° C., or about 1000° C. to about 1400° C., or any range encompassing these endpoints.

As discussed above, and as shown in FIG. 1C, the shaping components 125 apply a force on the molten glass material to produce a continuous glass sheet 129. In some embodiments, the shaping components 125 may also cool the molten glass material to form the glass sheet 129. Additionally or alternatively, in embodiments, one or more cooling devices may be disposed downstream of the shaping components 125 to cool the produced glass sheet 129. The glass sheet 129 may have a thickness of about 10.0 mm or less, or about 9.0 mm or less, or about 8.0 mm or less, or about 7.0 mm or less, or about 6.0 mm or less, or about 5.0 mm or less, or about 4.0 mm or less, or about 3.0 mm or less, or about 2.0 mm or less, or about 1.0 mm or less, or about 0.9 mm or less, or about 0.8 mm or less, or about 0.7 mm or less, or about 0.6 mm or less, or about 0.5 mm or less, or about 0.4 mm or less, or about 0.3 mm or less, or about 0.2 mm or less, or about 0.1 mm or less, or about 0.05 mm or less. Additionally or alternatively, the glass sheet 129 may have a thickness of about 0.05 mm or greater, or about 0.1 mm or greater, or about 0.2 mm or greater, or about 0.3 mm or greater, or about 0.4 mm or greater, or about 0.5 mm or greater, or about 0.6 mm or greater, or about 0.7 mm or greater, or about 0.8 mm or greater, or about 0.9 mm or greater, or about 1.0 mm or greater or about 2.0 mm or greater, or about 3.0 mm or greater, or about 4.0 mm or greater, or about 5.0 mm or greater. In embodiments, the thickness is in a range from about 0.05 mm to about 5.0 mm, or about 0.1 mm to about 4.0 mm, or about 0.2 mm to about 3.0 mm, or about 0.3 mm to about 2.0 mm, or about 0.4 mm to about 1.0 mm, or about 0.5 mm to about 0.9 mm, or about 0.6 mm to about 0.8 mm, or about 0.7 mm to about 0.8 mm, or any range encompassing these endpoints.

The glass sheet 129 may have a length in an x-axis direction of about 50 mm or greater, or about 100 mm or greater, or about 250 mm or greater, or about 500 mm or greater, or about 750 mm or greater, or about 1,000 mm or greater, or about 1,250 mm or greater, or about 1,500 mm or greater, or about 1,750 mm or greater, or about 2,000 mm or greater, or about 2,500 mm or greater, or about 5,000 mm or greater, or about 7,500 mm or greater, or about 10,000 mm or greater, or any range encompassing these endpoints. It is noted that the x-axis directional length of glass sheet 129 is perpendicular to the directional flow of glass sheet 129 from shaping components 125.

The produced glass sheet 129 has a uniform thickness and temperature profile. In embodiments, the produced glass sheet has a total thickness variation (TTV) across an entire x-axis directional length of the glass sheet of about 1 mm or less, or about 500 microns or less, or about 100 microns or less, or about 50 microns or less, or about 40 microns, or less, or about 30 microns or less, or about 20 microns or less, or about 10 microns or less, or about 5 microns or less, or about 2 microns or less, or about 1 micron or less, or about 0.5 microns or less, or in a range from about 0.5 microns to about 50 microns, or about 1 micron to about 40 microns, or about 2 microns to about 30 microns, or about 5 microns to about 20 microns, or about 10 microns to about 20 microns, or any range encompassing these endpoints. Furthermore, in embodiments, the produced glass sheet 129 has a temperature variation across an entire x-axis directional length of the glass sheet of about 10° C. or less, or about 9° C. or less, or about 8° C. or less, or about 7° C. or less, or about 6° C. or less, or about 5° C. or less, or about 4° C. or less, or about 4° C. or less, or about 3° C. or less, or about 2° C. or less or about 1° C. or less, or about 0.5° C. or less.

The produced glass sheet may have a refractive index (at a wavelength of 633 nm) of about 1.60 or greater, or about 1.65 or greater, or about 1.70 or greater, or about 1.75 or greater, or about 1.80 or greater, or about 1.85 or greater, or about 1.90 or greater, or about 1.95 or greater, or about 2.00 or greater, or about 2.05 or greater, or about 2.10 or greater, or about 2.15 or greater, or about 2.20 or greater. In embodiments, the refractive index of the produced glass sheet is in a range from about 1.60 to about 2.20, or about 1.65 to about 2.15, or to about 1.70 to about 2.10, or about 1.75 to about 2.05, or about 1.80 to about 2.00, or about 1.85 to about 1.95, or about 1.90 to about 1.95, or any range encompassing these endpoints. In embodiments, the produced glass sheet comprises at least one rare earth oxide, such as lanthanum oxide. In embodiments, the produced glass sheet comprises boron, titanium, and niobium.

In embodiments, the glass delivery system 100 may include one or more heating components 130 (as shown in FIG. 1A, for example) that are configured to heat the molten glass material. For example, the chamber 110 may be coupled with a heating component 130 configured to heat the chamber 110 such that the molten glass material is maintained at a desired temperature within the chamber 110. In some embodiments, the one or more heating components 130 may provide heat via direct power or by induction heating. Additionally, or alternatively, the glass delivery system 100 may include one or more cooling components (not shown) coupled with the described components of the glass delivery system 100. For example, a cooling component may be coupled with the chamber 110 and configured to cool the chamber 110 such that the molten glass material is maintained at a desired temperature within the chamber 110.

FIG. 1D shows a perspective view of the chamber 110 and distribution component 120 of the glass delivery system of FIGS. 1A and 1B. Furthermore, FIG. 1D also shows attachment components 127 (which are not shown in FIGS. 1A and 1B) coupled to chamber 110. Attachment components 127 may attach chamber 110 and distribution component 120 to a furnace assembly, for example. In some embodiments, attachment components 127 are brackets, mounting components, couplers, fasteners, and/or connectors. In yet some embodiments, attachment components 127 include electrical leads to power one or more components of delivery system 100. Furthermore, in FIG. 1D, shaping components 125 are depicted as two rollers, according to some embodiments disclosed herein.

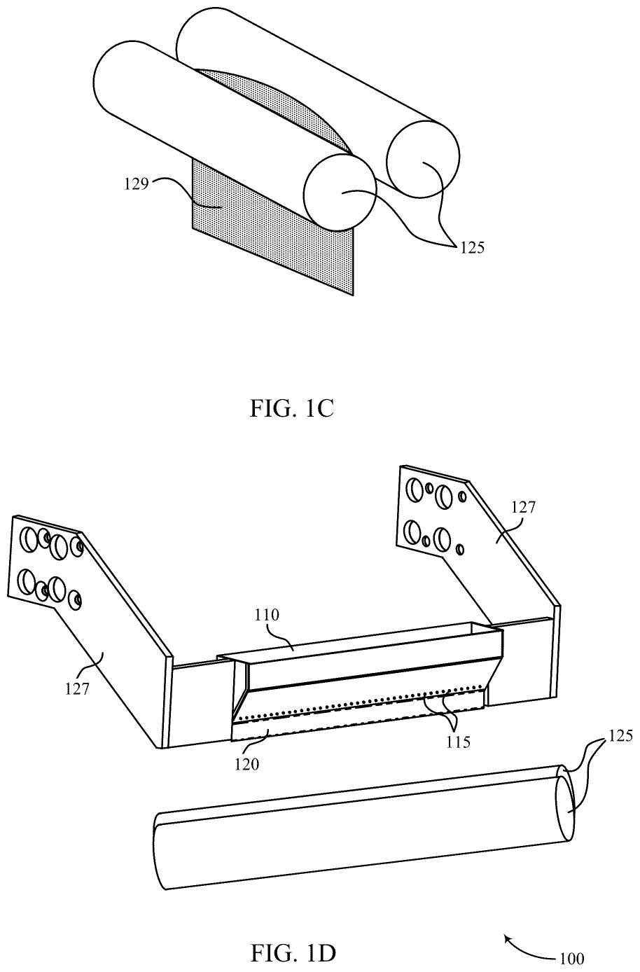

FIG. 2 shows an embodiment of the glass delivery system 100 in which molten glass material 102 flows within the opening 104 of the inlet component 105 and accumulates within cavity 112 of chamber 110 to form a reservoir 103. It is noted that the reservoir 103 of molten glass material 102 does not fill the entire volume cavity 112, in this embodiment, as it accumulates within cavity 112 before flowing within channels 115. The molten glass material 102 then flows within channels 115 and onto distribution component 120 before reaching shaping components 125.

In embodiments, the reservoir 103 of molten glass within cavity 112 has a height (H_{R}) of about 10 inches or less, or about 7.5 inches or less, or about 5 inches or less, or about 2.5 inches or less, or about 1 inches or less, or about 0.75 inches or less, or about 0.5 inches or less, or about 0.25 inches or less, or any range encompassing these endpoints. The height (H_{R}) should be of sufficient length to ensure a constant and steady flow of molten glass material into the channels 115. However, the length of height (H_{R}) can vary depending on the viscosity of the molten glass material 102 and the flow rate of the molten glass material 102 out of the channels 115. In embodiments, the height (H_{R}) can be relatively shorter with relatively lower glass viscosities, and the height (H_{R}) can be shorter with relatively larger flow rates out of the channels 115. An x-axis directional length of reservoir 103 (perpendicular to the height (H_{R})) may be equal to (or substantially equal to) a length of cavity 112.

As also discussed below with reference to FIG. 5, after the molten glass material 102 flows from channels 115 and from distribution component 120, it may form a puddle 200 before reaching shaping components 125. Thus, the molten glass material 102 may accumulate in puddle 200 before it is formed into the glass sheet 129.

With reference again to FIG. 2, the molten glass material 102 flows from the reservoir 103 of molten glass in cavity 112 and into channels 115 before flowing along distribution component 120. When the molten glass flows along distribution component 120, it flows in the shape of a molten glass body 108, which may be a cluster or grouping of the molten glass material 102. The molten glass body 108 may be formed by a grouping of individual droplets of molten glass material. In embodiments, the grouping may be a continuous grouping of the droplets of molten glass material. For example, in some embodiments, the molten glass body 108 is a single, unitary body formed of an agglomeration of the droplets of molten glass material. The shape of distribution component 120 allows the molten glass material 102 to from the molten glass body 108 along the distribution component 120.

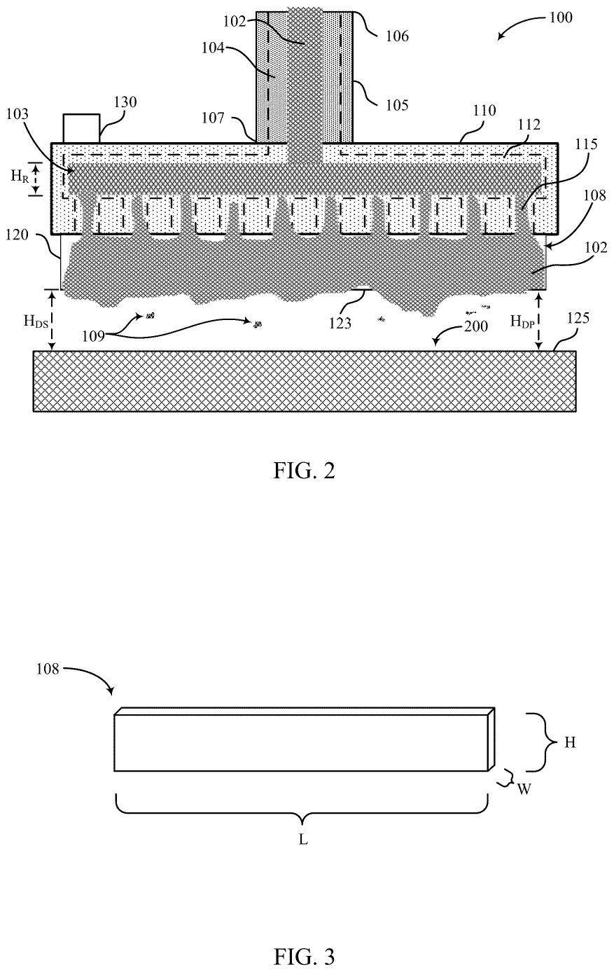

In embodiments, the molten glass body 108 may form a rectangular-like prism having a length and width, as discussed further below. FIG. 3 shows the cross-sectional view of the rectangular-like shape of molten glass body 108. However, it is noted that molten glass body 108 may not be a completely symmetrical rectangular shape with even sides as molten glass body 108 is formed of moving material that is continuously flowing from one component to another. But the overall shape of molten glass body 108 is generally in the form of a rectangular prism.

The molten glass body 108 is comprised of a unitary body of molten glass flowing along the distribution component 120. However, after the molten glass material 102 reaches lip 123 of distribution component 120 and flows off of the distribution component 120 (towards shaping components 125), the molten glass material 102 may no longer stay in the shape and form of the molten glass body 108 (as shown in FIG. 2). After flowing off of lip 123, the molten glass material 102 may no longer be a unitary body of molten glass. Instead, the molten glass material 102 may flow as discrete and separate droplets 109, as also shown in FIG. 2. The droplets 109 may each have a shape smaller than that of molten glass body 108. Furthermore, the droplets 109 may each have a unique and different shape from each other. In some embodiments, the droplets 109 form immediately after the molten glass material 102 flows from lip 123. In other embodiments, the droplets 109 form after the molten glass material 102 flows a certain distance from lip 123. Thus, in these latter embodiments, the molten glass material 102 flows as the molten glass body 108 from lip 123 and then, a certain distance from lip 123, the molten glass body 108 becomes separated into the droplets 109.

Droplets 109, in embodiments, may flow from lip 123 as discrete and separate members. In other embodiments, one or more droplets 109 may merge together when flowing from lip 123 towards shaping components 125. In yet some embodiments, one or more droplets 109 may merge together to form a stream of molten glass when flowing from lip 123 towards shaping components 125. Furthermore, in some embodiments, the molten glass material 102 may flow directly from lip 123 as one or more streams of molten glass. In yet some embodiments, a continuous flow of molten glass material 102 may flow from lip 123 and break down into the one or more streams of molten glass (e.g., several streams of glass) and/or the discrete droplets 109. For example, the molten glass material 102 may be a continuous glass body until leaving lip 123, at which point the molten glass material 102 may diverge into a plurality of separate streams of molten glass. It is contemplated in embodiments that the one or more streams and/or droplets 109 merge together before reaching shaping components 125. It is also contemplated in the embodiments disclosed herein that droplets 109 simultaneously and/or sequentially flow from lip 123 as the one or more streams of molten glass flow from lip 123. Thus, the molten glass material 102 may flow from lip 123 as a combination of droplets and different streams of molten glass.

Although the molten glass body 108 looses its shape once reaching lip 123 (and becomes droplets 109), in some embodiments, it is believed that the uniform body produced by molten glass body 108 helps to shape the molten glass delivered to the shaping components 125, thus producing a more uniform glass sheet from the shaping components 125. More specifically, the molten glass body 108 comprises a uniform (or substantially uniform) temperature profile of the molten glass. Although the molten glass body 108 may separate into droplets 109, the molten glass of the droplets 109 still maintains such uniformity, which is then carried through to the produced glass sheet 129. Therefore, the forming of the molten glass body 108 along distribution component 120 advantageously produces a more uniform final glass sheet.

It is also noted that in some embodiments, molten glass body 108 does indeed maintain its shape when flowing from lip 123 of distribution component 120 (rather than separate into droplets 109). In these embodiments, the molten glass material 102 continues to flow as the molten glass body 108 from lip 123 (rather than forming the discrete and separate droplets 109).

The production of the droplets 109 from lip 123 is also a function of the height (H_{DS}) between the lip 123 and the top of the shaping components 125 and/or the height (H_{DP}) between the lip 123 and the top of the puddle 200. As shown in FIG. 2, the height (H_{DS}) is the distance between the edge of the lip 123 of the distribution component 120 and the top of the shaping components 125 (e.g., the top of the rollers). In embodiments, the height (H_{DS}) is sufficiently long to enable the production of droplets 109 between the lip 123 and the shaping components 125. In other embodiments, the height (H_{DS}) is sufficiently short so that the molten glass body 108 flows directly into the shaping components 125 while maintaining its shape as a molten glass body 108. Therefore, in these latter embodiments, the height (H_{DS}) is small so that the droplets 109 do not form and instead the molten glass body 108 flows directly into the shaping components 125. This helps to produce a uniform body flowing into the shaping components 125, which helps to produce a uniform glass sheet. In some embodiments, the molten glass body 108 flows directly into the shaping components 125 so that the shaping components pull the molten glass body 108 directly from the distribution component 120 and into the shaping components 125.

As shown in FIGS. 2 and 5, the height (H_{DP}) is the distance between the edge of the lip 123 of the distribution component 120 and the top of the puddle 200. In embodiments, the height (H_{DP}) is sufficiently long to enable the production of droplets 109 between the lip 123 and the shaping components 125. In other embodiments, the height (H_{DP}) is sufficiently short so that the molten glass body 108 flows directly into the shaping components 125 while maintaining its shape as a molten glass body 108. Therefore, in these latter embodiments, the height (H_{DP}) is small so that the droplets 109 do not form and instead the molten glass body 108 flows directly into the shaping components 125. This helps to produce a uniform body flowing into the shaping components 125, which helps to produce a uniform glass sheet.

In some embodiments, when the height (H_{DP}) is about 20 mm or less, the molten glass body 108 flows directly into the shaping components 125 so that the droplets 109 do not form. More specifically, the molten glass body 108 flows directly into the shaping components 125 when the height (H_{DP}) is about 20 mm or less, or about 15 mm or less, or about 10 mm or less, or about 5 mm or less, or about 2 mm or less, or about 1 mm or less, or about 0.5 mm or less, or about 0 mm or less, or about −0.5 mm or less, or about −1 mm or less, or about −2 mm or less, or about −5 mm or less. In some embodiments, the lip 123 is at the same height as the top of the puddle 200, thus producing a height (H_{DP}) of 0 mm. In yet other embodiments, the lip 123 is immersed within the puddle 200 so that the lip 123 is positioned relatively closer to the shaping components 125 than the top of the puddle 200, thus producing a height (H_{DP}) of about −0.5 mm or less, or about −1 mm or less, or about −2 mm or less, or about −5 mm or less. The height (H_{DP}) may be in a range from about −5 mm to about 20 mm, or about −2 mm to about 15 mm, or about −1 mm to about 10 mm, or about −0.5 mm to about 5 mm, or about 0 mm to about 2 mm, or about 1 mm to about 2 mm, or any combination of ranges contemplated by these endpoints.

FIG. 3 shows the general shape of molten glass body 108. As discussed above, the molten glass body 108 is a rectangular-like prism formed of molten glass material as it flows along distribution component 120. Molten glass body 108 has a length (L), a height (H), and a width (W). The length (L) of molten glass body 108 extends along the length of distribution component 120 (in the X-axis direction) and, thus, along the length of the plurality of channels 115. However, the length (L) of molten glass body 108 may be shorter than the length of distribution component 120. The height (H) of molten glass body 108 extends in the flow direction of the molten glass material from channels 115 (in the Y-axis direction) and is perpendicular to the length (L). In embodiments, the height (H) of molten glass body 108 is the height of the distribution component 120. The width (W) of molten glass body 108 is the thickness of the body.

In embodiments, the length (L) of the molten glass body 108 is about 50 mm or greater, or about 75 mm or greater, or about 100 mm or greater, or about 125 mm or greater, or about 150 mm or greater, or about 175 mm or greater, or about 200 mm or greater, or about 225 mm or greater, or about 250 mm or greater, or about 300 mm or greater, or about 350 mm or greater, or about 400 mm or greater, or about 450 mm or greater, or about 500 mm or greater, or about 600 mm or greater, or about 700 mm or greater, or about 800 mm or greater, or about 900 mm or greater, or about 1000 mm or greater. Additionally or alternatively, the length (L) of the molten glass body 108 is about 1000 mm or less, or about 900 mm or less, or about 800 mm or less, or about 700 mm or less, or about 600 mm or less, or about 500 mm or less, or about 450 mm or less, or about 400 mm or less, or about 350 mm or less, or about 300 mm or less, or about 275 mm or less, or about 250 mm or less, or about 225 mm or less, or about 200 mm or less, or about 175 mm or less, or about 150 mm or less, or about 125 mm or less, or about 100 mm or less, or about 75 mm or less, or about 50 mm or less. In embodiments, the length (L) is in a range from about 50 mm to about 1000 mm, or about 75 mm to about 900 mm, or about 100 mm to about 800 mm, or about 125 mm to about 700 mm, or about 150 mm to about 600 mm, or about 175 mm to about 500 mm, or about 200 mm to about 450 mm or about 225 mm to about 400 mm, or about 250 mm to about 350 mm, or about 275 mm to about 400, or about 100 mm to about 500 mm, or about 200 mm to about 400 mm, or any range encompassing these endpoints.

In embodiments the width (W) of the molten glass body 108 is about 0.1 mm or greater, or about 0.2 mm or greater, or about 0.3 mm or greater, or about 0.4 mm or greater, or about 0.5 mm or greater, or about 0.6 mm or greater, or about 0.7 mm or greater, or about 0.8 mm or greater, or about 0.9 mm or greater, or about 1.0 mm or greater, or about 1.2 mm or greater, or about 1.4 mm or greater, or about 1.6 mm or greater, or about 1.8 mm or greater, or about 2.0 mm or greater, or about 2.2 mm or greater, or about 2.4 mm or greater, or about 2.6 mm or greater, or about 2.8 mm or greater, or about 3.0 mm or greater. Additionally or alternatively the width (W) of the molten glass material 108 is about 3.0 mm or less, or about 2.8 mm or less, or about 2.6 mm or less, or about 2.4 mm or less, or about 2.2 mm or less, or about 2.0 mm or less, or about 1.8 mm or less, or about 1.6 mm or less, or about 1.4 mm or less, or about 1.2 mm or less, or about 1.0 mm or less, or about 0.9 mm or less, or about 0.8 mm or less, or about 0.7 mm or less, or about 0.6 mm or less, or about 0.5 mm or less, or about 0.4 mm or less, or about 0.3 mm or less, or about 0.2 mm or less, or about 0.1 mm or less. In embodiments, the width (W) is from about 0.1 mm to about 3.0 mm, or about 0.2 mm to about 2.8 mm, or about 0.3 mm to about 2.6 mm, or about 0.4 mm to about 2.4 mm, or about 0.5 mm to about 2.2 mm, or about 0.6 mm to about 2.0 mm, or about 0.7 mm to about 1.8 mm, or about 0.8 mm to about 1.6 mm, or about 0.9 mm to about 1.4 mm, or about 1.0 mm to about 1.2 mm, or any range encompassing these endpoints.

The length (L) of the molten glass body 108 may be greater than the width (W) of the molten glass body 108. In embodiments a ratio of the length (L) of the molten glass body 108 to the width (W) of the molten glass body 108 (L: W) is about 20:1 or greater, or about 25:1 or greater, or about 30:1 or greater, or about 35:1 or greater, or about 40:1 or greater, or about 45:1 or greater, or about 50:1 or greater, or about 55:1 or greater, or about 60:1 or greater, or about 65:1 or greater, or about 70:1 or greater, or about 75:1 or greater or about 80:1 or greater, or about 85:1 or greater, or about 90:1 or greater, or about 95:1 or greater, or about 100:1 or greater, or about 200:1 or greater, or about 300:1 or greater, or about 400:1 or greater, or about 500:1 or greater, or about 600:1 or greater, or about 700:1 or greater, or about 800:1 or greater, or about 900:1 or greater, or about 1000:1 or greater. Additionally or alternatively, the ratio of the length (L) to the width (W) is about 1000:1 or less, or about 900:1 or less, or about 800:1 or less, or about 700:1 or less, or about 600:1 or less, or about 500:1 or less, or about 400:1 or less, or about 300:1 or less, or about 200:1 or less, or about 100:1 or less, or about 95:1 or less, or about 90:1 or less, or about 85:1 or less, or about 80:1 or less, or about 75:1 or less, or about 70:1 or less, or about 65:1 or less, or 60:1 or less, or about 55:1 or less, or about 50:1 or less, or about 45:1 or less, or about 40:1 or less, or about 35:1 or less, or about 30:1 or less, or about 25:1 or less, or about 20:1 or less. In embodiments, the ratio of the length (L) to the width (W) is in a range from about 20:1 to about 1000:1, or about 25:1 to about 900:1, or about 30:1 to about 800:1, or about 35:1 to about 700:1, or about 40:1 to about 600:1, or about 45:1 to about 500:1, or about 50:1 to about 400:1, or about 55:1 to about 300:1, or about 60:1 to about 200:1, or about 65:1 to about 100:1, or about 70:1 to about 95:1, or about 75:1 to about 90:1, or about 80:1 to about 85:1, or any range encompassing these endpoints.

In embodiments, a ratio of the length (L) of the molten glass body 108 to the height (H) of the molten glass body 108 (L:H) is about 1:1 or more, or about 2:1 or more, or about 5:1 or more, or about 10:1 or more, or about 20:1 or more, about 40:1 or more, or about 50:1 or more, or about 60:1 or more, or about 70:1 or more, or about 80:1 or more, or about 90:1 or more, or about 100:1 or more. Additionally or alternatively, the ratio of the length (L) to the height (H) is about 100:1 or less, or about 90:1 or less, or about 80:1 or less, or about 70:1 or less, or about 60:1 or less, or about 50:1 or less, or about 40:1 or less, or about 30:1 or less, or about 20:1 or less, or about 10:1 or less, or about 5:1 or less, or about 2:1 or less, or about 1:1 or less. In embodiments, the ratio of the length (L) to the height (H) is in a range from about 1:1 to about 100:1, or about 2:1 to about 90:1, or about 5:1 to about 80:1, or about 10:1 to about 70:1, or about 20:1 to about 60:1, or about 30:1 to about 50:1, or about 40:1 to about 50:1, or any range encompassing these endpoints. In embodiments, the length (L) is equal to (or substantially equal to) the height (H).

As discussed above, a flow rate of the molten glass material flowing within the molten glass body 108 is dependent on the size and shape of the individual channels 115 and also the total number of channels 115 in chamber 110. In embodiments, the channels 115 may be sized and shaped accordingly so that the molten glass material flows uniformly across the molten glass body 108. Therefore, for example, the size and shape of the channels 115 may be uniform across the chamber 110 and the number of channels 115 may be evenly dispersed across the chamber 110. In other embodiments, the channels 115 may be sized and shaped so that the molten glass material flows non-uniformly across the molten glass body 108.

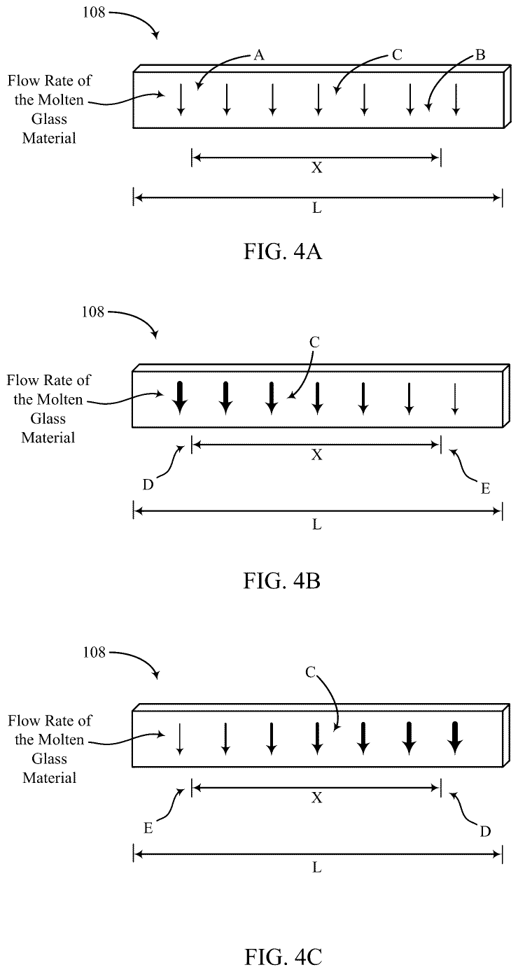

FIG. 4A shows an embodiment in which the flow rate of the molten glass material flows uniformly along the length (L) of the molten glass body 108. For purposes of the present disclosure, the uniformity of the flow rate is demonstrated using distance (X), which is a distance along the length (L) of the molten glass body 108 (in the X-axis direction). In embodiments, the distance (X) is about 50% or more, or about 60% or more, or about 70% or more, or about 80% or more, or about 90% or more, or about 95% or more, or about 100% of the length (L) of the molten glass body 108. The uniformity is then determined by calculating a difference between a flow rate of the molten glass material at any point along distance (X) and an average flow rate of the molten glass material across the entire length (L), which is referred to herein as “Equation 1.” In embodiments, the calculation of Equation 1 is about 5.0% or less of the average flow rate of the molten glass material across the entire length (L), thus showing the uniformity of the flow rate across the molten glass body 108. In embodiments, Equation 1 (the difference between the flow rate of the molten glass material at any point along distance (X) and an average flow rate of the molten glass material across the entire length (L)) is about 20.0% or less, or about 17.5% or less, or about 15.0% or less, or about 12.5% or less, or about 10.0% or less, or about 7.5% or less, or about 5.0% or less, or about 4.5% or less, or about 4.0% or less, or about 3.5% or less, or about 3.0% or less, or about 2.5% or less, or about 2.0% or less, or about 1.5% or less, or about 1.0% or less, or about 0.75% or less, or about 0.5 % or less or about 0.25% or less, or about 0.20% or less, or about 0.10% or less, or about 0.05% or less, or about 0.00% of the average flow rate of the molten glass material across the entire length (L), or any range encompassing these endpoints.

For example, in one exemplary embodiment, at any point along distance (X), such as at point A, the following calculation of Equation 1 shows the uniform flow rate throughout the molten glass body 108: (flow rate of molten glass material at point A)/(average flow of the molten glass material along length (L))=(5.0% or less of the average flow rate of the molten glass material along length (L)). To further illustrate this point, in this same exemplary embodiment, at another point along distance (X), such as at point B, the same calculation of Equation 1 can be used to show the uniform flow rate through the molten glass body 108: (flow rate of molten glass material at point B)/(average flow of the molten glass material along length (L))=(5.0% or less of the average flow rate of the molten glass material along length (L)).

In embodiments, Equation 1 satisfies the above-disclosed uniformity for each and every point of the molten glass body 108 along distance (X). Therefore, Equation 1 is about 20.0% or less, or about 17.5% or less, or about 15.0% or less, or about 12.5% or less, or about 10.0% or less, or about 7.5% or less, or about 5.0% or less, or about 4.5% or less, or about 4.0% or less, or about 3.5% or less, or about 3.0% or less, or about 2.5% or less, or about 2.0% or less, or about 1.5% or less, or about 1.0% or less, or about 0.75% or less, or about 0.5 % or less or about 0.25% or less, or about 0.20% or less, or about 0.10% or less, or about 0.05% or less, or about 0.00% of the average flow rate of the molten glass material across the entire length (L) for each and every point of the molten glass body 108 along distance (X).

In embodiments, the distance (X) overlaps with a center point C of the molten glass body 108, such that the flow rate of the molten glass material at center point C falls within the above described uniformity.

FIG. 4B shows another embodiment in which the flow rate of the molten material flows non-uniformly along the length (L) of the molten glass body 108. For example, in this embodiment, the left side of the molten glass body 108 comprises a larger flow rate than the right side of the molten glass body 108. Such non-uniformity may be due to a larger number of channels 115 on the left side and/or channels 115 with a relatively larger diameter on the left side.

FIG. 4C shows a similar embodiment in which the flow rate of the molten glass material flows non-uniformly along the length (L) of the molten glass body 108. But, in this embodiment, the right side of the molten glass body 108 comprises a larger flow rate than the left side of the molten glass body 108.

In the embodiments of FIGS. 4B and 4C, the flow rate of the molten glass material may be in a gradient, such that one side of the body has a relatively higher flow rate than the other side with a graded spectrum of flow rates therebetween. It is also contemplated that such a gradient may peak at a center portion of the molten glass body 108, such as at center point C, so that the center portion comprises the largest flow rate.

For purposes of the present disclosure, the non-uniformity of the flow rate (such as shown in FIGS. 4B and 4C) is also demonstrated using the distance (X). As discussed above, in embodiments, the distance (X) is about 50% or more, or about 60% or more, or about 70% or more, or about 80% or more, or about 90% or more, or about 95% or more, or about 100% of the length (L) of the molten glass body 108. The non-uniformity is determined by calculating a difference between a flow rate of the molten glass material at a first end D and a second end E of the distance (X). More specifically, the non-uniformity is determined by calculating a difference between the flow rate at the first end D and at the second end E, such that the flow rate of the molten glass material at the first end D is at least 5% greater than the flow rate of the molten glass material at the second end E, which is referred to herein as “Equation 2.” In embodiments, the flow rate of the molten glass material at the first end D is at least 5% greater, or at least 10% greater, or at least 15% greater, or at least 20% greater, or about 25% greater, or at least 30% greater, or about 35% greater, or at least 40% greater, or at least 45% greater, or at least 50% greater, or at least 55% greater, or at least 60% greater, or at least 65% greater, or at least 70% greater, or at least 75% greater, or at least 80% greater, or at least 85% greater, or at least 90% greater, or about least 95% greater, or at least 100% greater than the flow rate of the molten glass material at the second end E

For example, in one exemplary embodiment, the following calculation of Equation 2 shows the non-uniform flow rate throughout the molten glass body 108: (flow rate of molten glass material at first end D)−(flow rate of molten glass material at second end E) ≥5% of the flow rate of the molten glass material at the first end D.

As shown in FIG. 4B, in embodiments, the first end D is the left side of the molten glass body 108 and the second end E is the right side of the molten glass body 108. In other embodiments, as shown in FIG. 4C, the first end D is the right side of the molten glass body 108 and the second end E is the left side of the molten glass body 108 (depending on which side has the largest flow rate). In embodiments, the second end E is an opposing end from the first end D. However, it is also contemplated in embodiments that one or more of the first end D and the second end E is at a center portion of the molten glass body 108, such as at center point C.

In embodiments, as shown in FIG. 5 and as discussed above, the molten glass material 102 forms puddle 200 before reaching the shaping components 125. The puddle 200 may be positioned above and/or on the shaping components 125. In some embodiments, the molten glass material 102 may converge above the shaping components 125 to form the puddle 200 comprised of evenly distributed and uniform molten glass material.

In embodiments, the puddle 200 has a height (H_{P}), which is measured from the top of the molten glass within the puddle 200 (the molten glass material 102 within the puddle 200 that is closest to the distribution component 120) to a radial center of the shaping components 125, as shown in FIG. 5. In embodiments, the height (H_{P}) is about 50 mm or less, or about 45 mm or less, or about 40 mm or less, or about 35 mm or less, or about 30 mm or less, or about 25 mm or less, or about 20 mm or less, or about 15 mm or less, or about 10 mm or less, or about 5 mm or less. Additionally or alternatively the height (H_{P}) of puddle 200 is about 5 mm or greater, or about 10 mm or greater, or about 15 mm or greater, or about 20 mm or greater, or about 25 mm or greater, or about 30 mm or greater, or about 35 mm or greater, or about 40 mm or greater, or about 45 mm or greater, or about 50 mm or greater. In embodiments, the height (H_{P}) is from about 5 mm to about 50 mm, or about 10 mm to about 45 mm, or about 15 mm to about 40 mm, or about 20 mm to about 35 mm, or about 25 mm to about 30 mm, or any range encompassing these endpoints. The height (H_{P}) should be of sufficient length to remerge the molten glass into a continuous body, especially in the embodiments in which the discrete droplets 109 are formed.

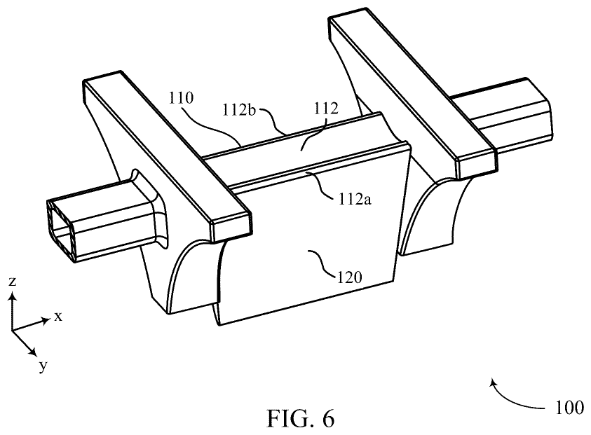

FIG. 6 shows another embodiment of glass delivery system 100 that supports distributed delivery of low viscosity glass in accordance with aspects of the present disclosure. In particular, FIG. 6 shows cavity 112 of chamber 110 as open and not completely enclosed by the walls of chamber 110. In this embodiment, the molten glass material 102 may form the reservoir 103 within cavity 112 and flow over the edges of cavity 112 and along distribution component 120. In embodiments, such as the embodiment shown in FIG. 6, cavity 112 comprises a first side 112a and an opposing second side 112b. Molten glass material 102 may flow from cavity 112 along both first and second sides 112a, 112b before flowing into shaping components 125. In some embodiments, distribution component 120 is only located along first side 112a of cavity 112 and is not located along second side 112b of cavity 112. Therefore, the molten glass material 102 flowing from cavity 112 along and around first side 112a flows along distribution component 120 before flowing into shaping components 125. However, the molten glass material 102 flowing from cavity 112 along and around second side 112b does not flow along a distribution component 120 and, instead, may flow directly into shaping components 125 from cavity 112. It is also note that in the embodiment of FIG. 6, the molten glass material 120 may flow into puddle 200 before reaching the shaping components 125.

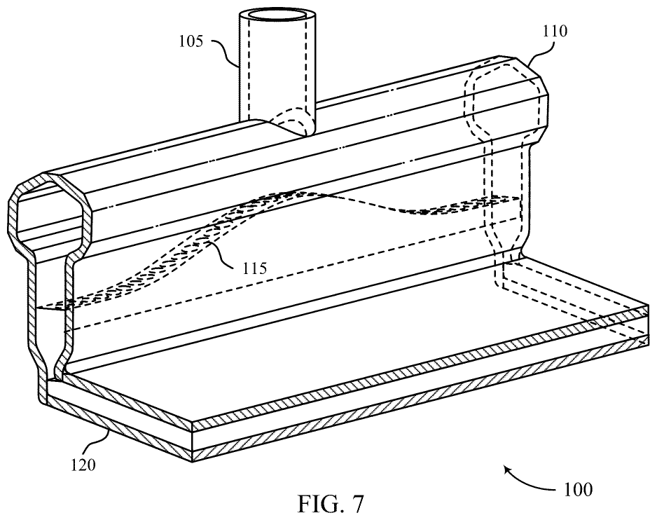

FIG. 7 shows another embodiment of glass delivery system 100 that supports distributed delivery of low viscosity glass in accordance with aspects of the present disclosure. In particular, FIG. 7 shows channels 115 as having varying heights along a length of chamber 110 (in the X-axis direction). In this particular embodiment, the height of channels 115 is in a linear or Gaussian distribution shape, such that the channels 115 near the center of the chamber 110 are taller than the channels near the edges of the chamber 110. However, it is also contemplated in other embodiments that the channels 115 near the center of the chamber 110 are shorter than the channels near the edges of the chamber 110. The different heights of the channels 115 allow glass delivery system 100 to control and specifically tailor the flow rate of the molten glass from the channels 115.

In embodiments, such as shown in the embodiment of FIG. 7, distribution component 120 may comprise two plate-like members that are oriented about 90 degrees with regard to the flow direction of the molten glass material (in the Y-axis direction) through the channels 115. The molten glass material 102 flows between the two plate-like members so that the molten glass body 108 is formed between these two plate-like members. The two plate-like members help to remerge the streams of molten glass material exiting the channels 115 to produce the continuous molten glass body 108. Furthermore, the two plate-like members advantageously reduce and/or prevent the formation of volatile gases from the molten glass material 102.

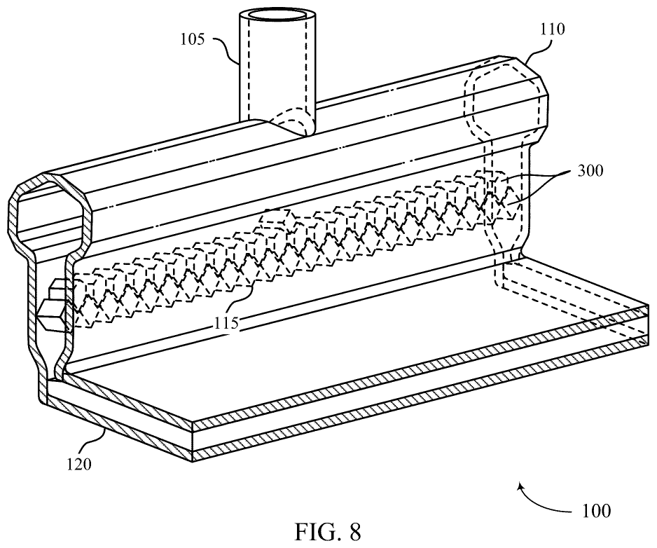

FIG. 8 shows another embodiment of glass delivery system 100 that supports distributed delivery of low viscosity glass in accordance with aspects of the present disclosure. In particular, FIG. 8 shows channels 115 as being formed by structures 300. Therefore, in these embodiments, the outer sidewalls of structures 300 form the passageway of channels 115. Furthermore, in these embodiments, channels 115 are not cylindrical members with straight sides. Instead, the outer sidewalls of structure 300 have protruding and receding shapes, thus providing channels 115 that are not symmetrically straight. In the embodiment shown in FIG. 8, structures 300 are hexagonal.

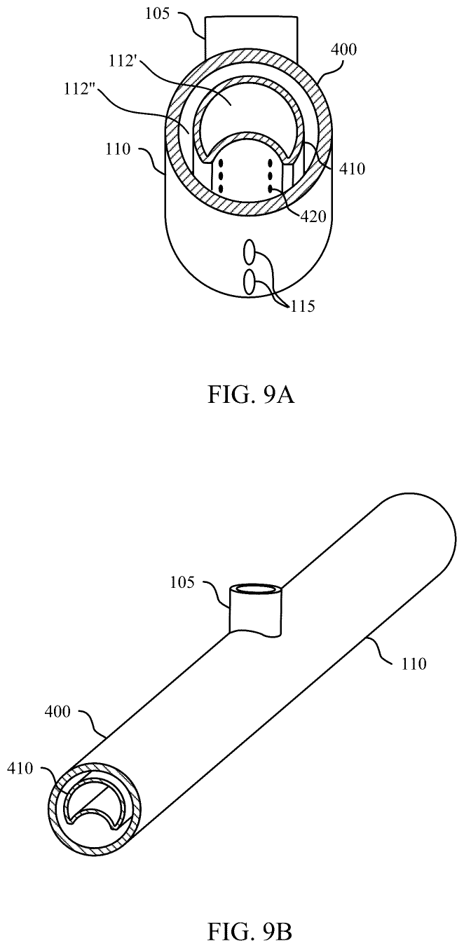

FIGS. 9A and 9B illustrate exemplary embodiments of chamber 110 in which the chamber comprises an internal compartment 410 surrounded by an external compartment 400. A first cavity 112′ is formed by internal compartment 410 and a second cavity 112″ is formed by external compartment 400. More specifically, first cavity 112′ is the internal channel formed within internal compartment 410. Second cavity 112″ is formed between an inner surface of external compartment 400 and an outer surface of internal compartment 410. In embodiments, the molten glass material from inlet component 105 flows first into internal compartment 410 and spreads out within first cavity 112′. Then, the molten glass material flows from first cavity 112′ to second cavity 112″ via channels 420. As shown in FIG. 9A, the channels 920 are separate and discrete passageways that restrict the flow of molten glass material. Therefore, some molten glass material may accumulate in first cavity 112′ and form a reservoir in the cavity (as discussed above with reference to FIG. 2).

The molten glass material my flow out of second cavity 112″ and towards shaping components 125 (and/or towards puddle 200) via channels 115, as discussed above. The molten glass material may also accumulate in second cavity 112″ and form a reservoir in the cavity before exiting the cavity via channels 115.

Although FIGS. 9A and 9B show internal compartment 410 as a kidney bean shape and external compartment as round in cross-section, these compartments may comprise other shapes and configurations than specifically shown herein.

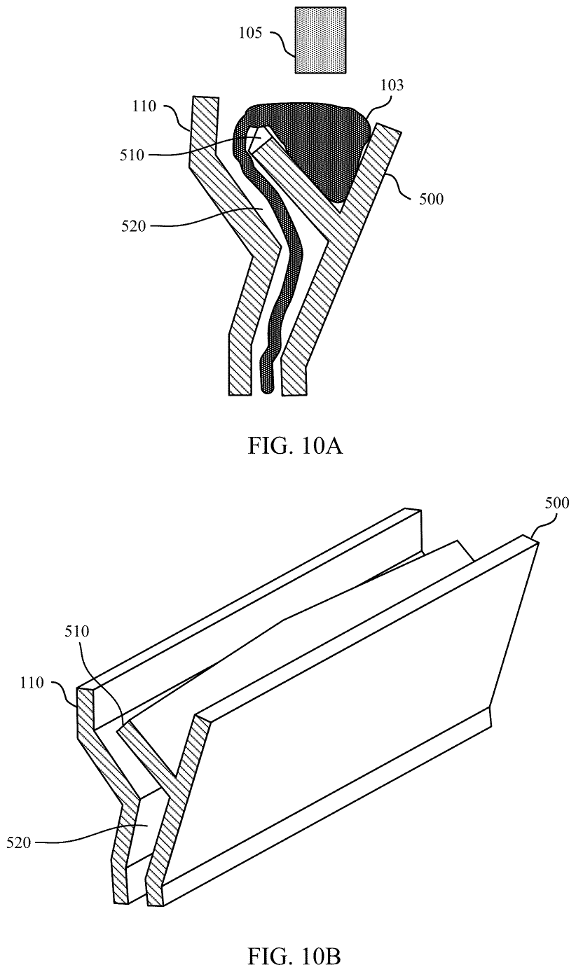

FIGS. 10A and 10B show yet another embodiment of chamber 110 in which the chamber comprises a well 500 that forms the reservoir 103 of the molten glass material. The molten glass material accumulates in the reservoir 103 until it eventually overflows the well 500 and flows over a rim 510 and down a passageway 520. An end of the passageway 520 may be the channels 115.

One or more of aspects of the above-disclosed embodiments may be combined with one or more aspects from other above-disclosed embodiments. For example, although disclosed with reference to FIG. 7, the distribution component 120 comprised of two plate-like members may be combined with other embodiments than that specifically shown in FIG. 7. As another example, the open cavity 112 of FIG. 6 may be combined with other embodiments than that specifically shown in FIG. 6.

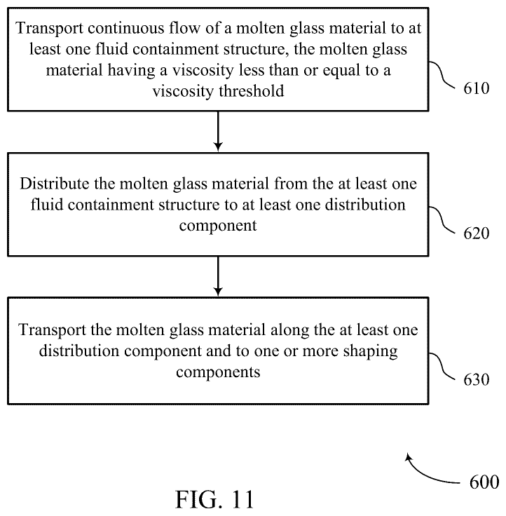

FIG. 11 shows a flowchart illustrating a method 600 that supports distributed delivery of low viscosity glass in accordance with aspects of the present disclosure. The operations of method 600 may be implemented by a glass forming system or its components as described herein. For example, the operations of method 600 may be performed by a glass forming system as described with reference to FIGS. 1A-10B. In some examples, a glass forming system may execute a set of instructions to control the functional elements of the glass forming system to perform the described functions. Additionally, or alternatively, the glass forming system may perform aspects of the described functions using special-purpose hardware.

At step 610, the method may include transporting a continuous flow of a molten glass material to at least one fluid containment structure (e.g., chamber 110), the molten glass material having a viscosity less than or equal to a viscosity threshold. The operations of step 610 may be performed in accordance with examples as disclosed herein. In some examples, aspects of the operations of step 610 may be performed by an inlet component.

At step 620, the method may include distributing the molten glass material from the at least one fluid containment structure to at least one distribution component. The operations of 620 may be performed in accordance with examples as disclosed herein. In some examples, aspects of the operations of 620 may be performed by a distribution component.

At step 630, the method may include transporting the molten glass material along the at least one distribution component and to one or more shaping components configured to form at least one glass sheet from the molten glass material, wherein the at least one glass sheet has an approximately uniform fluid profile and an approximately uniform temperature profile. The operations of 630 may be performed in accordance with examples as disclosed herein. In some examples, aspects of the operations of 630 may be performed by a plurality of shaping components.

In some examples, an apparatus as described herein may perform a method or methods, such as the method 600. The apparatus may include features, circuitry, logic, means, or instructions (e.g., a non-transitory computer-readable medium storing instructions executable by a processor) for transporting continuous flow of a molten glass material to the at least one fluid containment structure, along the distribution component, and to the one or more shaping components to form at least one glass sheet from the molten glass material, wherein the at least one glass sheet has an approximately uniform fluid profile and an approximately uniform temperature profile.

Some examples of the method 600 and the apparatus described herein may further include operations, features, means, or instructions for collecting the molten glass material in at least one reservoir of the at least one fluid containment structure and wherein the molten glass material may be transported to the one or more shaping components based at least in part on a quantity of the molten glass material collected in the at least one reservoir satisfying a capacity of the at least one reservoir.

In some examples of the method 600 and the apparatus described herein, transporting the molten glass material from the at least one fluid containment structure to the one or more shaping components may include operations, features, circuitry, logic, means, or instructions for delivering the molten glass material from the at least one fluid containment structure to one or more distribution components and delivering the molten glass material from the one or more distribution components to the one or more shaping components, wherein the at least one glass sheet may have the approximately uniform fluid profile and the approximately uniform temperature profile based at least in part on transporting the molten glass material via the one or more distribution components.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, Furthermore, may be practiced without these specific details. In some instances, well-known structures and devices are shown in block diagram form in order to avoid obscuring the concepts of the described examples.

The various illustrative blocks and modules described in connection with the disclosure herein may be implemented or performed with a general-purpose processor, a digital signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

According to a first aspect, a method of forming a glass sheet comprising flowing molten glass from one or more channels of a glass delivery system as a molten glass body to one or more shaping components, the molten glass having a viscosity of about 1000 poise or less, and the molten glass body having a length, a width, and a height such that the height extends in a direction from the one or more channels towards the shaping components and the length is perpendicular to the width, wherein a ratio of the length of the molten glass body to the width of the molten glass body is about 40:1 or greater and a difference between a flow rate of the molten glass body at any point along a distance of 80% or more of the length of the molten glass body and an average flow rate of the molten glass body across the entire length of the molten glass body is about 20.0% or less of the average flow rate of the molten glass across the entire length of the molten glass body.

According to a second aspect, the method of the first aspect, wherein the viscosity is about 500 poise or less.

According to a third aspect, the method of the second aspect, wherein the viscosity is about 250 poise or less.

According to a fourth aspect, the method of the third aspect, wherein the viscosity is about 100 poise or less.

According to a fifth aspect, the method of the fourth aspect, wherein the viscosity is about 50 poise or less.

According to a sixth aspect, the method of any one of the first through fifth aspects, wherein the ratio of the length of the molten glass body to the width of the molten glass body is about 40:1 to about 600:1.

According to a seventh aspect, the method of the sixth aspect, wherein the ratio of the length of the molten glass body to the width of the glass molten glass body is about 100:1 to about 600:1.

According to an eighth aspect, the method of any one of the first through seventh aspects, wherein a ratio of the length of the molten glass body to the height of the molten glass body is about 1:1 or more.

According to a ninth aspect, the method of any one of the first through eighth aspects, wherein the distance of 80% or more overlaps with a center point of the molten glass body.

According to a tenth aspect, the method of any one of the first through ninth aspects, wherein the difference between the flow rate of the molten glass at any point along the distance of 80% or more of the length of the molten glass body and the average flow rate of the molten glass across the entire length of the molten glass body is about 10.0% or less of the average flow rate of the molten glass across the entire length of the molten glass body.

According to an eleventh aspect, the method of the tenth aspect, wherein the difference between the flow rate of the molten glass at any point along the distance of 80% or more of the length of the molten glass body and the average flow rate of the molten glass across the entire length of the molten glass body is about 5.0% or less of the average flow rate of the molten glass across the entire length of the molten glass body.

According to a twelfth aspect, the method of the eleventh aspect, wherein the difference between the flow rate of the molten glass at any point along the distance of 80% or more of the length of the molten glass body and the average flow rate of the molten glass across the entire length of the molten glass body is about 2.0% or less of the average flow rate of the molten glass across the entire length of the molten glass body.

According to a thirteenth aspect, the method of any one of the first through twelfth aspects, wherein a difference between a flow rate of the molten glass at any point along a distance of 90% or more of the length of the molten glass body and an average flow rate of the molten glass across the entire length of the molten glass body is about 20.0% or less of the average flow rate of the molten glass across the entire length of the molten glass body.

According to a fourteenth aspect, the method of any one of the first through thirteenth aspects, wherein a difference between a flow rate of the molten glass at any point along a distance of 95% or more of the length of the molten glass body and an average flow rate of the molten glass across the entire length of the molten glass body is about 20.0% or less of the average flow rate of the molten glass across the entire length of the molten glass body.

According to a fifteenth aspect, the method of any one of the first through fourteenth aspects, wherein the length of the molten glass body is between about 100 mm and about 500 mm.

According to a sixteenth aspect, the method of the fifteenth aspect, wherein the length of the molten glass body is between about 200 mm and about 400 mm.

According to a seventeenth aspect, the method of any one of the first through sixteenth aspects, wherein the width of the molten glass body is between about 0.1 mm and about 3.0 mm.

According to an eighteenth aspect, the method of the seventeenth aspect, wherein the width of the molten glass body is between about 0.25 mm and about 2.0 mm.

According to a nineteenth aspect, the method of any one of the first through eighteenth aspects, further comprising forming a puddle of the molten glass above the shaping components, the puddle having a height of less than about 20 mm, the height of the puddle being from a top of the molten glass within the puddle 200 to a radial center of the shaping components.

According to a twentieth aspect, the method of the nineteenth aspect, wherein the height of the puddle is about 10 mm or less.

According to a twenty-first aspect, the method of any one of the first through twentieth aspects, wherein the one or more shaping components comprise at least two rollers.

According to a twenty-second aspect, a method of forming a glass sheet comprising flowing molten glass from one or more channels of a glass delivery system as a molten glass body to one or more shaping components, the molten glass having a viscosity of about 1000 poise or less, and the molten glass body having a length, a width, and a height such that the height extends in a direction from the one or more channels towards the shaping components and the length is perpendicular to the width, wherein a ratio of the length of the molten glass body to the width of the molten glass body is about 40:1 or greater and a portion of the molten glass body that spans a distance of at least 80% of the length of the molten glass body comprises a first end and a second end, and a flow rate of the molten glass at the first end is at least 5% greater than a flow rate of the molten glass at the second end of the molten glass body.

According to a twenty-third aspect, the method of the twenty-second aspect, wherein the viscosity is about 500 poise or less.

According to a twenty-fourth aspect, the method of the twenty-third aspect, wherein the viscosity is about 250 poise or less.

According to a twenty-fifth aspect, the method of the twenty-fourth aspect, wherein the viscosity is about 100 poise or less.

According to a twenty-sixth aspect, the method of the twenty-fifth aspect, wherein the viscosity is about 50 poise or less.

According to a twenty-seventh aspect, the method of any one of the twenty-second through twenty-sixth aspects, wherein the ratio of the length of the molten glass body to the width of the molten glass body is about 40:1 to about 600:1.

According to a twenty-eighth aspect, the method of the twenty-seventh aspect, wherein the ratio of the length of the molten glass body to the width of the glass molten glass body is about 100:1 to about 600:1.

According to a twenty-ninth aspect, the method of any one of the twenty-second through twenty-eighth aspects, wherein a ratio of the length of the molten glass body to the height of the molten glass body is about 1:1 or more.

According to a thirtieth aspect, the method of any one of the twenty-second through twenty-ninth aspects, wherein the distance of 80% or more overlaps with a center point of the molten glass body.

According to a thirty-first aspect, the method of any one of the twenty-second through thirtieth aspects, wherein the flow rate of the molten glass at the first end of the is at least 20% greater than a flow rate of the molten glass at the second end of the molten glass body.

According to a thirty-second aspect, a method of forming a glass sheet comprising flowing molten glass in a y-axis direction from one or more channels of a glass delivery system to one or more shaping components, the molten glass having a viscosity of about 250 poise or less, and rolling the molten glass into a continuous glass sheet with the one or more shaping components, the continuous glass sheet having a thickness of about 10.0 mm or less and a length in an x-axis direction of about 100 mm or greater.

According to a thirty-third aspect, a glass manufacturing apparatus comprising a glass delivery system comprising a chamber with at least a first channel and a second channel, and one or more shaping components downstream of the chamber. The first channel and the second channel being configured to deliver molten glass from the chamber to the one or more shaping components such that the first channel is configured to deliver the molten glass from the chamber at a different flow rate from the second channel, and the shaping components being configured to roll the molten glass into a continuous glass sheet. Furthermore, the one or more shaping components comprising at least two rollers with a diameter of about 1 inch or greater.

According to a thirty-fourth aspect, the glass manufacturing apparatus of the thirty-third aspect, wherein a gap between the rollers is from about 0.1 mm to about 10 mm, the gap being the shortest distance between outer surfaces of the rollers.

According to a thirty-fifth aspect, the glass manufacturing apparatus of thirty-third or thirty-fourth aspects, further comprising a distribution component between the chamber and the one or more shaping components.

According to a thirty-sixth aspect, the glass manufacturing apparatus of the thirty-fifth aspect, wherein the distribution component comprises a plate-like member that extends from the chamber.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method of forming a glass sheet, the method comprising:
flowing molten glass from one or more channels of a glass delivery system as a molten glass body to one or more shaping components, the molten glass having a viscosity of about 1000 poise or less, and the molten glass body having a length, a width, and a height such that the height extends in a direction from the one or more channels towards the shaping components and the length is perpendicular to the width,
wherein:
a ratio of the length of the molten glass body to the width of the molten glass body is about 40:1 or greater, and
a difference between a flow rate of the molten glass body at any point along a distance of 80% or more of the length of the molten glass body and an average flow rate of the molten glass body across the entire length of the molten glass body is about 20.0% or less of the average flow rate of the molten glass across the entire length of the molten glass body.

2. The method of claim 1, wherein the viscosity is about 500 poise or less.

3. The method of claim 2, wherein the viscosity is about 100 poise or less.

4. The method of claim 1, wherein the ratio of the length of the molten glass body to the width of the glass molten glass body is about 100:1 to about 600:1.

5. The method of claim 1, wherein a ratio of the length of the molten glass body to the height of the molten glass body is about 1:1 or more.

6. The method of claim 1, wherein the distance of 80% or more overlaps with a center point of the molten glass body.

7. The method of claim 1, wherein the difference between the flow rate of the molten glass at any point along the distance of 80% or more of the length of the molten glass body and the average flow rate of the molten glass across the entire length of the molten glass body is about 10.0% or less of the average flow rate of the molten glass across the entire length of the molten glass body.

8. The method of claim 1, wherein a difference between a flow rate of the molten glass at any point along a distance of 90% or more of the length of the molten glass body and an average flow rate of the molten glass across the entire length of the molten glass body is about 20.0% or less of the average flow rate of the molten glass across the entire length of the molten glass body.

9. The method of claim 1, wherein a difference between a flow rate of the molten glass at any point along a distance of 95% or more of the length of the molten glass body and an average flow rate of the molten glass across the entire length of the molten glass body is about 20.0% or less of the average flow rate of the molten glass across the entire length of the molten glass body.

10. The method of claim 1, wherein the length of the molten glass body is between about 100 mm and about 500 mm.

11. The method of claim 1, wherein the width of the molten glass body is between about 0.1 mm and about 3.0 mm.

12. The method of claim 11, wherein the width of the molten glass body is between about 0.25 mm and about 2.0 mm.

13. The method of claim 1, further comprising forming a puddle of the molten glass above the shaping components, the puddle having a height of less than about 20 mm, the height of the puddle being from a top of the molten glass within the puddle 200 to a radial center of the shaping components.

14. The method of claim 13, wherein the height of the puddle is about 10 mm or less.

15. The method of claim 1, wherein the one or more shaping components comprise at least two rollers.

16. A method of forming a glass sheet, the method comprising:
flowing molten glass from one or more channels of a glass delivery system as a molten glass body to one or more shaping components, the molten glass having a viscosity of about 1000 poise or less, and the molten glass body having a length, a width, and a height such that the height extends in a direction from the one or more channels towards the shaping components and the length is perpendicular to the width,
wherein:
a ratio of the length of the molten glass body to the width of the molten glass body is about 40:1 or greater, and
a portion of the molten glass body that spans a distance of at least 80% of the length of the molten glass body comprises a first end and a second end, and a flow rate of the molten glass at the first end is at least 5% greater than a flow rate of the molten glass at the second end of the molten glass body.

17. The method of claim 16, wherein the viscosity is about 500 poise or less.

18. The method of claim 17, wherein the viscosity is about 100 poise or less.

19. The method of claim 16, wherein the flow rate of the molten glass at the first end of the is at least 20% greater than a flow rate of the molten glass at the second end of the molten glass body.

20. A method of forming a glass sheet, the method comprising:
flowing molten glass in a y-axis direction from one or more channels of a glass delivery system to one or more shaping components, the molten glass having a viscosity of about 250 poise or less; and
rolling the molten glass into a continuous glass sheet with the one or more shaping components, the continuous glass sheet having a thickness of about 10.0 mm or less and a length in an x-axis direction of about 100 mm or greater.
